(19) United States
(12) Patent Application Publication
(10) Pub. No.: US 2026/0228489 A1
(43) Pub. Date: Aug. 6, 2026

(54) SYSTEMS AND METHODS FOR MITIGATING CATASTROPHIC FORGETTING IN FINE-TUNED LARGE LANGUAGE MODELS

(71) Applicant: INTUIT INC., Mountain View, CA (US)

(72) Inventors: Guy LEV, Tel Aviv (IL); Matan VETZLER, Tel Aviv (IL); Omer WOSNER, Tel Aviv (IL); Lior Vassertail AZROEL, Tel Aviv (IL)

(73) Assignee: INTUIT INC., Mountain View, CA (US)

(21) Appl. No.: 19/043,361

(22) Filed: Jan. 31, 2025

(51) Int. Cl. G06N 3/045; G06N 3/048

(52) U.S. Cl. CPC G06N 3/045; G06N 3/048

(57) ABSTRACT

A system and method are provided for mitigating catastrophic forgetting in fine-tuned large language models.

### BACKGROUND OF THE DISCLOSURE

Large language models (“LLMs”) are frequently fine-tuned on domain-specific data to refine their capabilities and improve their accuracy and performance for particular tasks and within particular domains. In other words, fine-tuning can turn a more general LLM into a specialized model, such as for financial and tax-related tasks and questions. However, when LLMs are fine-tuned on domain-specific data, the models frequently perform poorly on more general data. Moreover, the LLMs can lose their ability to generalize across diverse tasks. This reduces the efficacy of LLMs in practical applications where they would be expected to handle a variety of inquiries and data types, which is undesirable.

### BRIEF DESCRIPTION OF THE FIGURES

FIG. 1 is an example prior art multi-head attention layer.

FIG. 2 is a multi-head attention layer for mitigating catastrophic forgetting in fine-tuned LLMs according to example embodiments of the present disclosure.

FIG. 3 is a flowchart of an example process for mitigating catastrophic forgetting in fine-tuned LLMs according to example embodiments of the present disclosure.

FIG. 4 is a diagram of an example computing device or server device.

FIG. 5 is another example of a computing device.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

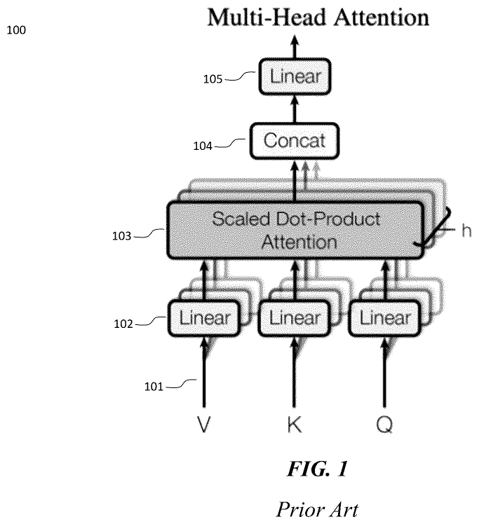

FIG. 1 is an example prior art multi-head attention layer 100. Such a multi-head attention layer 100 is typically one of several multi-head attention layers within the transformer of an LLM. Generally speaking, an LLM as described herein can include various models, such as GPT-3, -3.5, -4, PaLM-E, Ernie Bot, LLaMa, and others. In some embodiments, the LLM can include various transformer-based models trained on vast corpuses of data that utilize an underlying neural network. The various transformer-based models can utilize various multi-head attention layers, such as the multi-head attention layer 100 of FIG. 1, which includes various linear layers 102, an attention layer 103, a concatenation layer 104, and another linear layer 105.

However, with this type of architecture, catastrophic forgetting can frequently occur, where the model “forgets” information that it had previously learned after being trained on a new task. This can cause inaccuracies and various other undesirable phenomena that decrease the usefulness of LLMs as the attention layer 103 forgets information from the fine-tuning on specific data.

Embodiments of the present disclosure are therefore directed to a system and method that utilizes an improved multi-head attention layer. The disclosed multi-head attention layer can include a gating mechanism that can mitigate catastrophic forgetting. For example, the gating mechanism can receive the input of the attention layers and calculate a corresponding gate vector based on the attention layer inputs. In other words, the gate vector can be a function of the input and various learnable weights. The gate vector can then be applied to the outputs of the multiple heads, providing a “soft selection” of a subset of the heads' outputs. Such a gating mechanism can encourage the overall model to learn to assign part of the attention heads to handle domain-specific input, while the rest of the heads can be utilized to handle general inputs.

By adding a gating mechanism to the output of the heads' outputs, the system can more accurately make predictions regarding both general inquiries and specific inquiries, as the head outputs can be selectively weighted such that some heads handle general inquiries and other heads handle specific inquiries, thus reducing catastrophic forgetting.

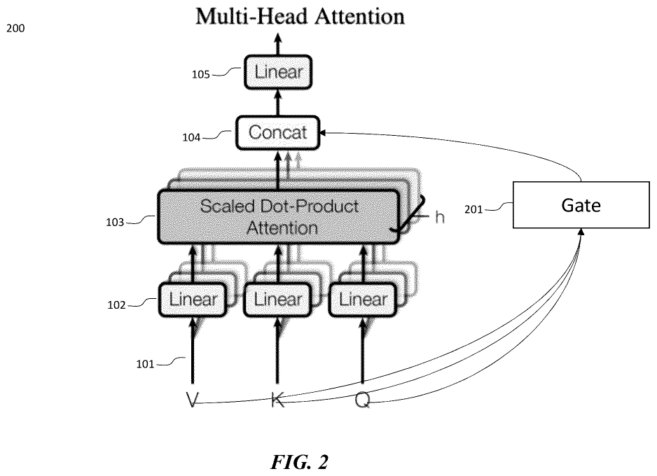

FIG. 2 is a multi-head attention layer 200 for mitigating catastrophic forgetting in fine-tuned LLMs according to example embodiments of the present disclosure. Similar to the multi-head attention layer 100 of FIG. 1, the multi-head attention layer 100 can receive various inputs 101 (e.g., textual inputs from users or other types of inputs if the multi-head attention layer 100 is an intermediate layer within the model) at its linear layers 102. In some embodiments, the multi-head attention layer 100 can include various depths of layers 102 (also referred to as “linear layers”). The layers 102 can process the inputs 101 and provide outputs to various attention layers 103. In some embodiments, the attention layer 103 can be a scaled dot-product attention layer. In some embodiments, attention layers 103 can enable the model to learn and determine dependencies between various components within input sequences. The attention output from the attention layer 103 can then be fed to a concatenation layer 104, which can merge outputs from the attention layers. The merged outputs can be provided to a linear layer 105, or various other types of layers.

In some embodiments, the multi-head attention layer 200 can receive various inputs 101 at its linear layers 102, and the multi-head attention layer 100 can include various depths of linear layers 102. In some embodiments, inputs V, K, and Q can be matrices. Each of these matrices can contain vector representations calculated for the input tokens fed to the model. In some embodiments, the difference between V, K and Q is that each can represent a different “role” of the input tokens in the attention calculation, where the different “roles” are: value, key, and query. For example, based on n number of tokens in the input sequence and a size k of token representations within each of the matrices V, K, and Q, the size of each can be n×k. In some embodiments, the depth can refer to the number of attention heads. Moreover, the disclosed transformer architecture can utilize multiple heads—the advantage of this is representing the input from different “aspects.” The disclosed system can leverage this architecture and enable, by the gating mechanism, training the model to select part of the heads for domain-specific inputs and part of the heads for general-data inputs. The linear layers 102 can similarly process the inputs 101 and provide outputs to various attention layers 103. Moreover, the attention layer 103 can be a scaled dot-product attention layer. In some embodiments, as described above, attention layers 103 can enable the model to learn and determine dependencies between various components within input sequences.

The multi-head attention layer 200 can include a gate 201. The gate 201 can receive the input 101 and generate a gate vector based on the received input. In some embodiments, generating the gate vector can include multiplying the input 101 by a plurality of matrices with learnable weights. In some embodiments, a single attention head can output a vector representation of size d for each token, and a vector T_i can be obtained by concatenating the outputs of all attention heads for the ith token; the size of this vector would be h×d, where h represents the number of attention heads and d represents the size of the vector representation of a token. Then, the gate vector 201 can be computed by applying a sigmoid function to the result of applying a linear function to V, K, and Q. An example function is shown below in Equation 1:

$$G = Sigmoid ( {AVA}^{′} + {BKB}^{′} + {CQC}^{′} ) \qquad ( 1 )$$

where G represents the gate vector; V, K, and Q represent the inputs 101; and A, A′, B, B′, C and C′ represent matrices with learnable weights. In some embodiments, A, B, and C can have a size of h×n and A′, B′, and C′ can have a size of k×d. In some embodiments, the gate vector can have values in the range [0,1] and a dimension of the number of attention heads by the dimension of the head outputs. In some embodiments, the gate 201 can apply the function via the element-wise multiplication of G. In some embodiments, the weights can be trained in various fashions, such as using back propagation and a gradient-descent-based algorithm.

The attention outputs from the attention heads 103 can then be fed to a concatenation layer 104, which concatenates the outputs of the attention heads. This means that: (1) for each token, each attention head can output a vector representation for that token. (2) The concatenation layer can concatenate, for each token, the vector representations obtained by the attention heads for that token. Then, the gate vector from the gate 201 can be applied to the output of the concatenation layer 104, meaning that the gate is applied (by performing element-wise multiplication) to the concatenated representation of each token. The resulting vectors obtained by applying the gate, can be provided to a linear layer 105, or various other types of layers. The application of the gate vector to the outputs of the attention layers 103 can provide a “soft selection” of a subset of the heads' outputs. This can encourage the model to learn to assign part of the attention heads to handle domain-specific input, while the rest of the heads are utilized to handle general input, which can ultimately reduce catastrophic forgetting.

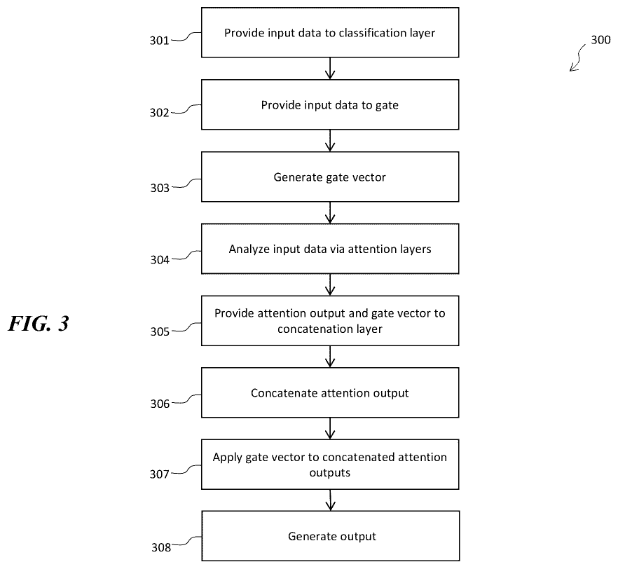

FIG. 3 is a flowchart of an example process 300 for mitigating catastrophic forgetting in fine-tuned LLMs according to example embodiments of the present disclosure. At block 301, the process 300 can include providing input data to a linear layer (e.g., linear layers 102 of FIG. 2). In some embodiments, the linear layer can include a plurality of linear layers, and the plurality of linear layers can be arranged in multiple depths. At block 302, the process 300 can include providing the input data to a gate (e.g., gate 201 of FIG. 2). At block 303, the process 300 can include generating, via a gate-calculation function, a gate vector based on the received input. As discussed above in relation to FIG. 2, generating the gate vector can include multiplying the input 101 by a plurality of matrices with learnable weights and then applying a sigmoid function to the result (see Equation 1 above).

At block 304, the process 300 can include analyzing the input data via a plurality of attention layers (e.g., attention layers 103 of FIG. 2). As described above, attention layers can be used to enable the model to learn and determine dependencies between various components within input sequences of the input data. For example, the learnable weights can be trained in various fashions, such as using back propagation and a gradient-descent-based algorithm. At block 305, the process 300 can include providing the output from the attention layers (i.e., “attention output”) and the gate vector from the gate to a concatenation layer (e.g., concatenation layer 104 of FIG. 2). At block 306, the process 300 can include concatenating the attention output and, at block 307, applying the gate vector to the concatenated attention outputs. As discussed above, the concatenation layer can then merge outputs from the attention layers based on the gate vector. The application of the gate vector to the outputs of the attention layers can provide a “soft selection” of a subset of the heads' outputs. This can encourage the model to learn to assign part of the attention heads to handle domain-specific input, while the rest of the heads are utilized to handle general input, which can ultimately reduce catastrophic forgetting. In some embodiments, block 306 can include concatenating the outputs of the attention heads. The concatenation layer 104 can concatenate, for each token, the vector representations from each attention head (i.e., each depth) for that token. Then, at block 307, the gate vector can be applied to the output of the concatenation layer 104, meaning that the gate vector (via element-wise multiplication) is applied to the concatenated representation of each token. At block 308, the process 300 can include generating an output based on the result of applying the gate vector to the concatenation output, which can be provided as a true output or as an input to additional layer within a transformer architecture.

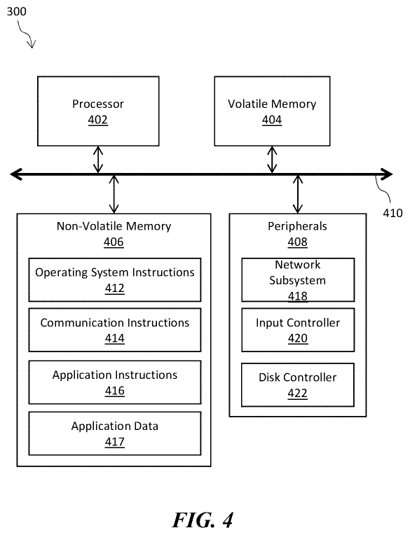

FIG. 4 is a diagram of an example computing device or server device. Server 400 can implement various features and processes as described herein. Server 400 can be implemented on any electronic device that runs software applications derived from complied instructions, including without limitation personal computers, servers, smart phones, media players, electronic tablets, game consoles, email devices, etc. In some implementations, server 400 can include one or more processors 402, volatile memory 404, non-volatile memory 406, and one or more peripherals 408. These components can be interconnected by one or more computer buses 410.

Processor(s) 402 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 410 can be any known internal or external bus technology, including but not limited to ISA, EISA, PCI, PCI Express, USB, Serial ATA, or FireWire. Volatile memory 404 can include, for example, SDRAM. Processor 402 can receive instructions and data from a read-only memory or a random access memory or both. Essential elements of a computer can include a processor for executing instructions and one or more memories for storing instructions and data.

Non-volatile memory 406 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 406 can store various computer instructions including operating system instructions 412, communication instructions 414, application instructions 416, and application data 417. Operating system instructions 412 can include instructions for implementing an operating system (e.g., Mac OS®, Windows®, or Linux). The operating system can be multi-user, multiprocessing, multitasking, multithreading, real-time, and the like. Communication instructions 414 can include network communications instructions, for example, software for implementing communication protocols, such as TCP/IP, HTTP, Ethernet, telephony, etc. Application instructions 416 can include instructions for various applications. Application data 417 can include data corresponding to the applications.

Peripherals 408 can be included within server device 400 or operatively coupled to communicate with server device 400. Peripherals 408 can include, for example, network subsystem 418, input controller 420, and disk controller 422. Network subsystem 418 can include, for example, an Ethernet of WiFi adapter. Input controller 420 can be any known input device technology, including but not limited to a keyboard (including a virtual keyboard), mouse, track ball, and touch-sensitive pad or display. Disk controller 422 can include one or more mass storage devices for storing data files; such devices include magnetic disks, such as internal hard disks and removable disks; magneto-optical disks; and optical disks.

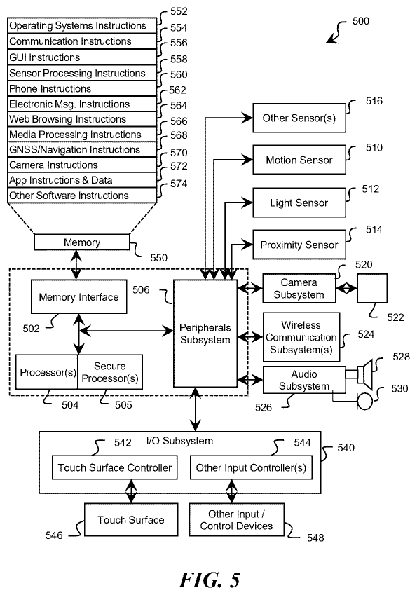

FIG. 5 is another example of a computing device. The illustrative user device 500 can include a memory interface 502, one or more data processors, image processors, central processing units 504, and or secure processing units 505, and peripherals subsystem 506. Memory interface 502, one or more central processing units 504 and or secure processing units 505, and or peripherals subsystem 506 can be separate components or can be integrated in one or more integrated circuits. The various components in user device 500 can be coupled by one or more communication buses or signal lines.

Sensors, devices, and subsystems can be coupled to peripherals subsystem 506 to facilitate multiple functionalities. For example, motion sensor 510, light sensor 512, and proximity sensor 514 can be coupled to peripherals subsystem 506 to facilitate orientation, lighting, and proximity functions. Other sensors 516 can also be connected to peripherals subsystem 506, such as a global navigation satellite system (GNSS) (e.g., GPS receiver), a temperature sensor, a biometric sensor, magnetometer, or other sensing device, to facilitate related functionalities.

Camera subsystem 520 and optical sensor 522, e.g., a charged coupled device (CCD) or a complementary metal-oxide semiconductor (CMOS) optical sensor, can be utilized to facilitate camera functions, such as recording photographs and video clips. Camera subsystem 520 and optical sensor 522 can be used to collect images of a user to be used during authentication of a user, e.g., by performing facial recognition analysis.

Communication functions can be facilitated through one or more wired and or wireless communication subsystems 524, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 524. The specific design and implementation of communication subsystems 524 can depend on the communication network(s) over which the user device 500 is intended to operate. For example, user device 500 can include communication subsystems 524 designed to operate over a GSM network, a GPRS network, an EDGE network, a WiFi or WiMax network, and a Bluetooth™ network. For example, wireless communication subsystems 524 can include hosting protocols such that device 500 can be configured as a base station for other wireless devices and or to provide a WiFi service.

Audio subsystem 526 can be coupled to speaker 528 and microphone 530 to facilitate voice-enabled functions, such as speaker recognition, voice replication, digital recording, and telephony functions. Audio subsystem 526 can be configured to facilitate processing voice commands, voice-printing, and voice authentication, for example.

I/O subsystem 540 can include a touch-surface controller 542 and or other input controller(s) 544. Touch-surface controller 542 can be coupled to a touch-surface 546. Touch-surface 546 and touch-surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 546.

The other input controller(s) 544 can be coupled to other input/control devices 548, such as one or more buttons, rocker switches, thumb-wheel, infrared port, USB port, and or a pointer device such as a stylus. The one or more buttons (not shown) can include an up/down button for volume control of speaker 528 and or microphone 530.

In some implementations, a pressing of the button for a first duration can disengage a lock of touch-surface 546; and a pressing of the button for a second duration that is longer than the first duration can turn power to user device 500 on or off. Pressing the button for a third duration can activate a voice control, or voice command, module that enables the user to speak commands into microphone 530 to cause the device to execute the spoken command. The user can customize a functionality of one or more of the buttons. Touch-surface 546 can, for example, also be used to implement virtual or soft buttons and or a keyboard.

In some implementations, user device 500 can present recorded audio and or video files, such as MP3, AAC, and MPEG files. In some implementations, user device 500 can include the functionality of an MP3 player, such as an iPod™. User device 500 can, therefore, include a 36-pin connector and or 8-pin connector that is compatible with the iPod. Other input/output and control devices can also be used.

Memory interface 502 can be coupled to memory 550. Memory 550 can include high-speed random access memory and or non-volatile memory, such as one or more magnetic disk storage devices, one or more optical storage devices, and or flash memory (e.g., NAND, NOR). Memory 550 can store an operating system 552, such as Darwin, RTXC, LINUX, UNIX, OS X, Windows, or an embedded operating system such as VxWorks.

Operating system 552 can include instructions for handling basic system services and for performing hardware dependent tasks. In some implementations, operating system 552 can be a kernel (e.g., UNIX kernel). In some implementations, operating system 552 can include instructions for performing voice authentication.

Memory 550 can also store communication instructions 554 to facilitate communicating with one or more additional devices, one or more computers and or one or more servers. Memory 550 can include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic messaging-related process and functions; web browsing instructions 564 to facilitate web browsing-related processes and functions; media processing instructions 566 to facilitate media processing-related functions and processes; GNSS/Navigation instructions 568 to facilitate GNSS and navigation-related processes and instructions; and or camera instructions 570 to facilitate camera-related processes and functions.

Memory 550 can store application (or “app”) instructions and data 572, such as instructions for the apps described above in the context of FIGS. 1-3. Memory 550 can also store other software instructions 574 for various other software applications in place on device 500.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A multi-head attention layer of a transformer architecture comprising:
a plurality of linear layers configured to receive an input, the plurality of linear layers arranged in multiple depths of linear layers;
a plurality of attention layers, each attention layer configured to receive an output of a depth of linear layers;
a gate configured to receive the input and calculate a gate vector as a function of the input and a plurality of learnable weights; and
a concatenation layer configured to concatenate the attention layer outputs and apply the gate vector to the concatenated attention layer outputs to generate an output.

2. The multi-head attention layer of claim 1, wherein the gate is arranged in parallel with the plurality of attention layers.

3. The multi-head attention layer of claim 1, wherein the gate calculates the gate vector using a sigmoid function.

4. The multi-head attention layer of claim 3, wherein the gate calculates the gate vector by multiplying the input by a plurality of matrices with learnable weights to create a product and applying the sigmoid function to the product.

5. The multi-head attention layer of claim 3, wherein the gate vector has a dimension of a number of attention layers by a dimension of the output from the plurality of attention layers.

6. The multi-head attention layer of claim 1, wherein each of the plurality of attention layers comprises a scaled dot-product attention layer.

7. A computer-implemented method, performed by at least one processor, comprising:
providing input data to a linear layer of a multi-head attention layer of a transformer architecture;
providing the input data to a gate;
generating, via the gate, a gate vector as a function of the input data and a plurality of learnable weights;
analyzing the input data via a plurality of attention layers to create an attention output;
providing the attention output and the gate vector to a concatenation layer;
concatenating the attention output; and
applying the gate vector to the concatenated attention output, thereby generating an output.

8. The computer-implemented method of claim 7, wherein the gate is arranged in parallel with the plurality of attention layers.

9. The computer-implemented method of claim 7, wherein generating the gate vector comprises using a sigmoid function.

10. The computer-implemented method of claim 9, wherein generating the gate vector comprises multiplying the input data by a plurality of matrices with learnable weights to create a product and applying the sigmoid function to the product.

11. The computer-implemented method of claim 7, wherein the gate vector has a dimension of a number of attention layers by a dimension of the output from the plurality of attention layers.

12. The computer-implemented method of claim 7, wherein each of the plurality of attention layers comprises a scaled dot-product attention layer.

13. The computer-implemented method of claim 7, wherein the linear layer comprises a plurality of linear layers arranged in multiple depths of linear layers.

14. A computing system comprising:
a processor; and
a non-transitory computer-readable storage device storing computer-executable instructions, the instructions when executed by the processor cause the processor to perform operations comprising:
providing input data to a linear layer of a multi-head attention layer of a transformer architecture;
providing the input data to a gate;
generating, via the gate, a gate vector as a function of the input data and a plurality of learnable weights;
analyzing the input data via a plurality of attention layers to create an attention output;
providing the attention output and the gate vector to a concatenation layer;
concatenating the attention output; and
applying the gate vector to the concatenated attention output, thereby generating an output.

15. The computing system of claim 14, wherein the gate is arranged in parallel with the plurality of attention layers.

16. The computing system of claim 14, wherein generating the gate vector comprises using a sigmoid function.

17. The computing system of claim 16, wherein generating the gate vector comprises multiplying the input data by a plurality of matrices with learnable weights to create a product and applying the sigmoid function to the product.

18. The computing system of claim 14, wherein the gate vector has a dimension of a number of attention layers by a dimension of the output from the plurality of attention layers.

19. The computing system of claim 14, wherein each of the plurality of attention layers comprises a scaled dot-product attention layer.

20. The computing system of claim 14, wherein the linear layer comprises a plurality of linear layers arranged in multiple depths of linear layers.
